(19) United States
(12) Patent Application Publication
(10) Pub. No.: US 2021/0321600 A1
(43) Pub. Date: Oct. 21, 2021

(54) DEVICE AND METHOD FOR DELIVERING STEAM ONTO AND BENEATH A FIELD SURFACE

(71) Applicant: X-Steam-Inator Agricultural Products, Ltd., Chaplin (CA)

(72) Inventor: Ronald Gleim, Chaplin (CA)

(73) Assignee: X-Steam-Inator Agricultural Products, Ltd., Chaplin, SK (CA)

(21) Appl. No.: 16/470,492

(22) PCT Filed: Jan. 7, 2019
(86) PCT No.: PCT/CA2019/050016

§ 371 Date: Jun. 17, 2019

(30) Foreign Application Priority Data
Jan. 8, 2018 (CA) 2991231

(51) Int. Cl. A01M 3/00

(52) U.S. Cl. CPC A01M 3/007

(57) ABSTRACT

A steam sprayer for delivering steam onto and beneath a field surface is provided. The steam sprayer comprises a support frame having a plurality of steam spraying nozzles mounted thereto and oriented substantially downwardly for spraying steam onto and beneath the field surface. At least a steam generator is connected to the steam spraying nozzles for providing steam thereto. A water heating tank is connected to each of the at least a steam generator for providing heated water at a substantially constant pressure thereto, Compressed air is provided to the water heating tank for pressurizing the water heating tank. Power is provided to the water heating tank and each of the at least a steam generator.

### FIELD OF THE INVENTION

The present invention relates to agricultural implements, and more particularly to a device and method for delivering steam onto and beneath a field surface.

### BACKGROUND OF THE INVENTION

In present-day large-scale crop production farmers apply large amounts of herbicides such as, for example, Glysophate, on agricultural fields for weed control. The application of large amounts of these herbicides has a detrimental impact on the environment by tainting the soil and nearby waterways for extended periods of time, as well as on the consumer of the agricultural products with these herbicides being deposited on the crops itself posing substantial health risks. Furthermore, repeated application of the same herbicide on the same field causes weeds to become resistant to the herbicide, thus requiring application of ever more potent herbicides over time.

Consequently, organic farming has been gaining widespread acceptance with both farmers and consumers. However, farmers using organic crop production methods are prevented from using herbicides for weed control, leaving only frequent tillage before seeding and on summer fallow for weed control. Therefore, farmers using organic crop production methods often loose a large amount of their crops due to uncontrollable weeds that overgrow and choke the crops.

While, steam sprayers for weed control are known in the art they are, typically, small devices with hand held wands for use in horticulture or small mobile units for small scale organic farming, which are not adaptable for large-scale crop production on agricultural fields with hundreds of acres in size.

It is desirable to provide a device and method for delivering steam onto and beneath a field surface for large-scale crop production.

It is also desirable to provide a device for delivering steam onto and beneath a field surface that covers a span of at least 20 feet to a maximum 200 feet and is capable of providing a substantially constant stream of steam at a temperature above 110° C. and at a pressure in the range of 10 to 150 psi to each of the steam spraying nozzles disposed along the span.

It is also desirable to provide a device for delivering steam onto and beneath a field surface that is remotely controllable.

### SUMMARY OF THE INVENTION

Accordingly, one object of the present invention is to provide a device and method for delivering steam onto and beneath a field surface for large-scale crop production.

Another object of the present invention is to provide a device for delivering steam onto and beneath a field surface that covers a span of at least 20 feet to a maximum 200 feet and is capable of providing a substantially constant stream of steam at a temperature above 110° C. and at a pressure in the range of 10 to 150 psi to each of the steam spraying nozzles disposed along the span.

Another object of the present invention is to provide a device for delivering steam onto and beneath a field surface that is remotely controllable.

According to one aspect of the present invention, there is provided a steam sprayer for delivering steam onto and beneath a field surface. The steam sprayer comprises a support frame having a plurality of steam spraying nozzles mounted thereto and oriented substantially downwardly for spraying steam onto and beneath the field surface. At least a steam generator is connected to the steam spraying nozzles for providing steam thereto. A water heating tank is connected to each of the at least a steam generator for providing heated water at a substantially constant pressure thereto. Compressed air is provided to the water heating tank for pressurizing the water heating tank. Power is provided to the water heating tank and each of the at least a steam generator.

According to the aspect of the present invention, there is provided a steam sprayer for delivering steam onto and beneath a field surface. The steam sprayer comprises a support frame having a plurality of steam spraying nozzles mounted thereto and oriented substantially downwardly for spraying steam onto and beneath the field surface. At least a steam generator is connected to the steam spraying nozzles for providing steam thereto. A water heating tank is connected to each of the at least a steam generator for providing heated water at a substantially constant pressure thereto. Compressed air is provided to the water heating tank for pressurizing the water heating tank. Power is provided to the water heating tank and each of the at least a steam generator. The steam sprayer further comprises at least a steam pressure and a steam temperature sensor for sensing pressure and temperature of the steam sprayed from at least one steam spraying nozzle. A processor is connected to: the at least a steam pressure and a steam temperature sensor; the means for providing power to the water heating tank and each of the at least a steam generator; the means for providing compressed air; the water pump; and a human machine interface. The processor controls: provision of power to the water heating tank and each of the at least a steam generator; provision of water to the water heating tank; and provision of compressed air to the water heating tank, in dependence upon: steam pressure and steam temperature data received from the least a steam pressure and a steam temperature sensor; and user input data received from the human machine interface.

According to the aspect of the present invention, there is provided a steam sprayer for delivering steam onto and beneath a field surface. The steam sprayer comprises a support frame covering a span of at least 20 feet to a maximum 200 feet. A plurality of steam spraying nozzles are mounted to the support frame along the span thereof and oriented substantially downwardly for spraying steam onto and beneath the field surface. A at least one steam generator is connected to the steam spraying nozzles for providing steam thereto. Heated water at a substantially constant pressure is provided to each of the steam generators. Power is provided to each of the steam generators.

According to the aspect of the present invention, there is provided a method for delivering steam onto and beneath a field surface comprising. A support frame covering a span of at least 20 feet to a maximum 200 feet is provided. A plurality of steam spraying nozzles are mounted to the support frame along the span and oriented substantially downwardly for spraying steam onto and to beneath the field surface. A substantially constant stream of steam at a temperature above 110° C. and at a pressure in the range of 10 to 150 psi is provided to each of the steam spraying nozzles while the steam sprayer is moved in a forward direction at a predetermined speed.

The advantage of the present invention is that it provides a device and method for delivering steam onto and beneath a field surface for large-scale crop production.

A further advantage of the present invention is that it provides a device for delivering steam onto and beneath a field surface that covers a span of at least 20 feet to a maximum 200 feet and is capable of providing a substantially constant stream of steam at a temperature above 110° C. and at a pressure in the range of 10 to 150 psi to each of the steam spraying nozzles disposed along the span.

A further advantage of the present invention is to provide a device for delivering steam onto and beneath a field surface that is remotely controllable.

### BRIEF DESCRIPTION OF THE DRAWINGS

A preferred embodiment of the present invention is described below with reference to the accompanying drawings, in which:

FIG. 1a is a simplified block diagram illustrating a top view of the steam sprayer according to a preferred embodiment of the invention with the steam sprayer coupled to a tractor and water storage tank;

FIGS. 1b and 1c are simplified block diagrams illustrating a top view and a side view, respectively, of the steam sprayer according to the preferred embodiment of the invention;

FIG. 1d is a simplified block diagram illustrating a detailed side view of the steam sprayer according to the preferred embodiment of the invention;

FIG. 2 is a simplified block diagram illustrating power provision to the components of the steam sprayer according to the preferred embodiment of the invention; and

FIG. 3 is a simplified block diagram illustrating control circuitry connected to the components of the steam sprayer according to the preferred embodiment of the invention.

### DESCRIPTION OF THE PREFERRED EMBODIMENT

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

While the description of the preferred embodiments hereinbelow is with reference to a steam sprayer for being coupled to a tractor via a drawbar, it will become evident to those skilled in the art that the embodiments of the invention are not limited thereto, but are also adaptable for coupling the steam sprayer to a tractor via a three-point hitch or for providing the steam sprayer as a self-propelled unit.

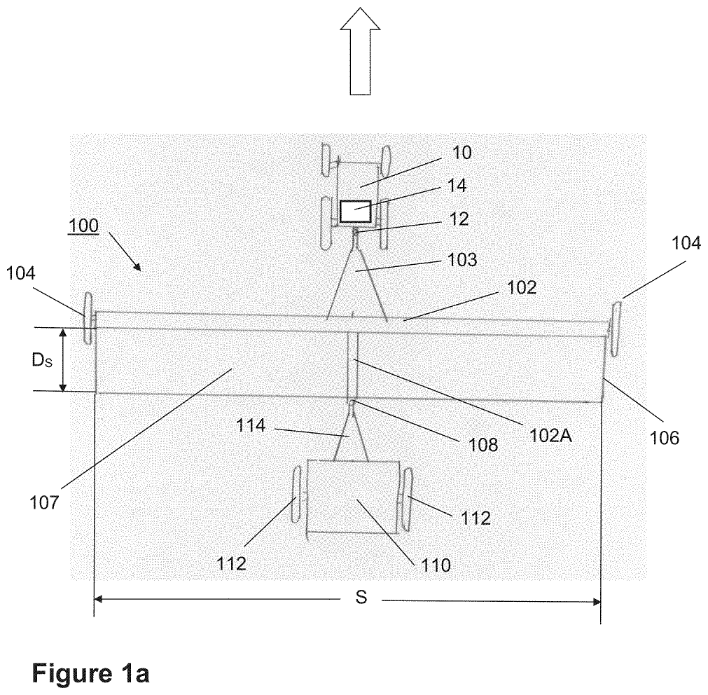

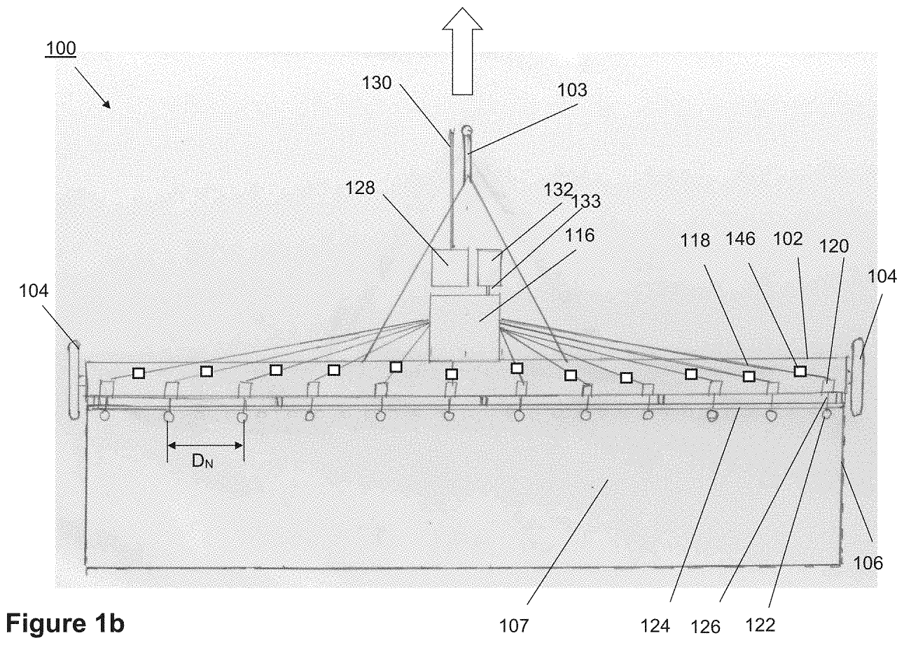

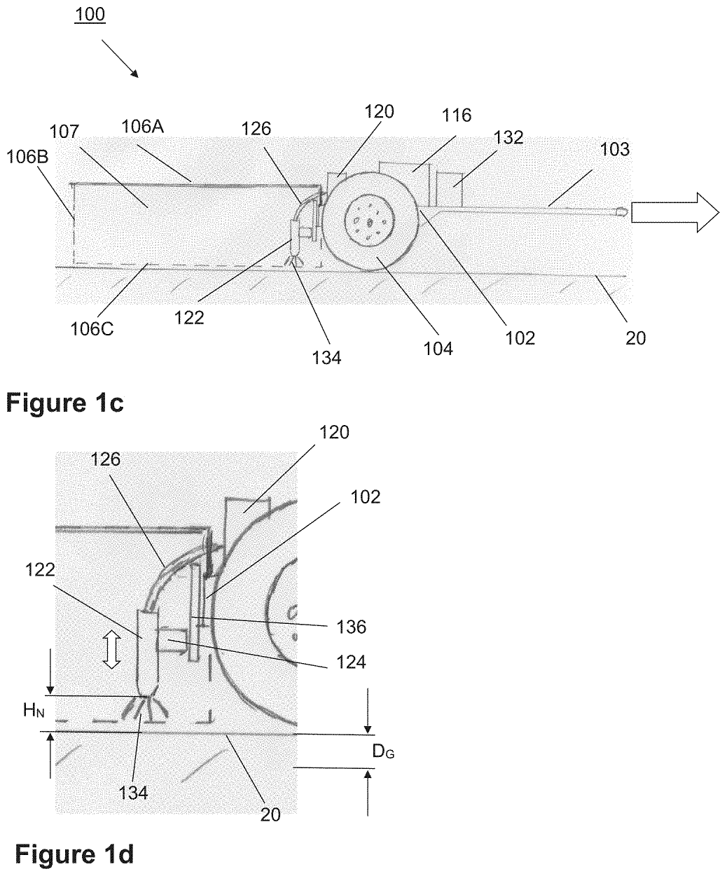

Referring to FIGS. 1a to 1d, a steam sprayer 100 for delivering steam onto and beneath a field surface according to a preferred embodiment of the invention is provided. The steam sprayer 100 preferably comprises a support frame 102 having wheels 104 rotatable movable mounted thereto in a conventional fashion. The support frame 102 is of conventional metal frame design employed in manufacturing farm implements made of, for example, steel, and has a span S of at least 20 feet to a maximum 200 feet. The support frame 102 is coupled to hitch 12 of tractor 10 via drawbar 103 mounted thereto for pulling the same along a forward direction, as indicated by the block arrow in FIGS. 1a to 1c. Steam spraying nozzles 122 are mounted to the support frame 102 along the span S thereof in an equidistant fashion having distance D_{N}—for example, 30 inches—therebetween and are oriented substantially downwardly for spraying steam 134 of sufficient pressure onto and beneath the field surface 20 a distance D_{G} of 1.5 to 3 inches, as illustrated in FIG. 1d. Preferably, the steam spraying nozzles 122 are vertically movable mounted to the support frame 102 via nozzle support frame 124 which is mounted to nozzle adjusting mechanism 136 for enabling vertical adjustment of the steam spraying nozzles 122, as indicated by the block arrow in FIG. 1d, such that a bottom end of the steam spraying nozzles 122 is placed at a predetermined height H_{N} above the field surface 20, for example, of 6 to 24 inches. The nozzle adjusting mechanism 136 comprises, for example, a vertically oriented guiding structure of conventional design and conventional hydraulic actuators. Alternatively, the steam spraying nozzles 122 are directly mounted to the support frame 102 which comprises a vertical adjusting mechanism interposed between the same and the wheels 104.

Preferably, each steam spraying nozzle 122 is directly connected to a respective steam generator 120 via steam conduit 126 for receiving in operation a substantially constant stream of steam at a temperature above 110° C. (up to 350° C.) and at a pressure in the range of 10 to 150 psi therefrom. The steam conduits 126 are, for example, conventional high-pressure piping or high-pressure hoses connected to the steam spraying nozzles 122 and the steam generator 120 using conventional high-pressure fittings. Alternatively, a plurality of steam spraying nozzles 122 are connected to one steam generator 120. The steam generators 120 are, for example, electrically heated spiral coil monotube low water-content boilers of conventional design.

Each steam generator 120 is—preferably individually—connected to water heating tank 116 via hot water conduit 118 for receiving heated water at a substantially constant pressure in the range of 10 to 150 psi therefrom. The hot water conduits 118 are, for example, conventional high-pressure piping or high-pressure hoses connected to the water heating tank 116 and the steam generators 120 using conventional high-pressure fittings. Further preferably, a Pressure Sustaining Valve (PSV) 146 of conventional design is interposed between each steam generator 120 and the water heating tank 116 for ensuring substantially constant pressure of the hot water. Alternatively, at least one steam generator 120 is connected to the water heating tank 116 via a same hot water conduit 118 and branching therefrom. The water heating tank 116 is of conventional design comprising, for example, electric heating elements disposed in a high-pressure tank.

In order to ensure substantially constant pressure of the hot water during operation, the water heating tank 116 is pressurized to a pressure in the range of 10 to 150 psi. Preferably, compressed air is used for pressurizing the water heating tank 116, with the compressed air being provided, for example, by a conventional electrically powered air compressor 132 connected to the water heating tank 116 via compressed air conduit 133. Alternatively, the water heating tank 116 is pressurized using pressurized water, for example, by pumping water from the water storage tank 110 to the water heating tank 116.

Preferably, the water storage tank 110 is provided as a separate wheel supported unit 112 for being coupled, for example, to hitch 108 of the steam sprayer 100 via drawbar 114 with the hitch 108, for example, being mounted to a rearwardly oriented extension 102A of the support frame 102. Provision of the water storage tank 110 as a separate unit enables flexibility with respect to the size of the water storage tank 110, for example, enabling employment of a substantially large sized tank.

Preferably, the various components of the steam sprayer 100 are electrically powered, as will be described hereinbelow, with the electrical power being provided by a conventional electrical generator 128 generating AC or DC electrical power and being driven by drive shaft 130 which is adapted for being coupled to a Power Take Off (PTO) of the tractor 10. Alternatively, other power sources are employed such as, for example, an internal combustion engine mounted to the support frame 102, coupling to a hydraulic system of the tractor 10, or a combination thereof.

Further preferably, the steam sprayer 100 comprises a shroud 106 mounted to the support frame 102 and extending a distance Ds, for example, 8 feet, from the steam spraying nozzles 122 in a rearward direction. The shroud 106 comprises a top cover 106A and walls 106B—sides and rear—hanging therefrom in a substantially downward oriented direction with a bottom end 106C of the walls being placed in close proximity to the field surface 20 forming enclosure 107 above the field surface 20 for containing the steam therein. The top cover 106A comprises, for example, a metal frame structure mounted to the support frame 102 and covered with a tarpaulin type sheet material, while the walls 106B comprise the same tarpaulin type sheet material. Alternatively, the shroud 106 is made of a more rigid material such as, for example, sheet metal or plastic sheet material.

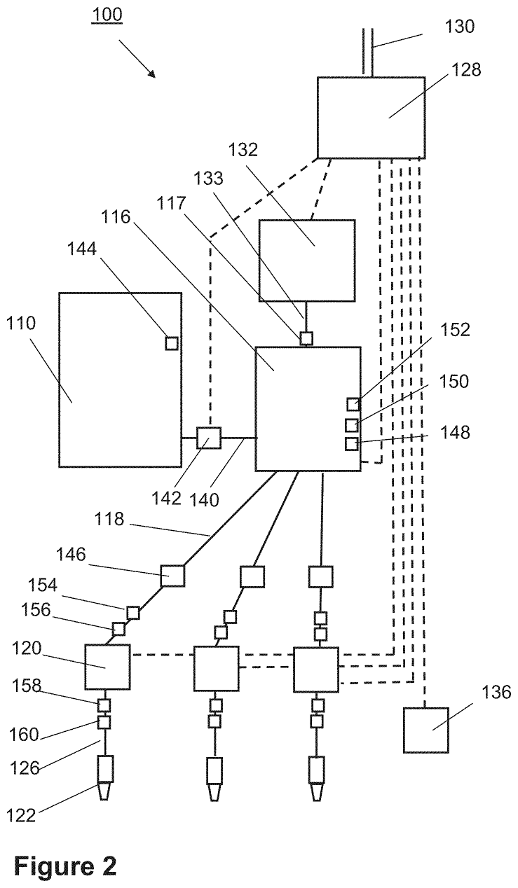

FIG. 2 illustrates the power provision to the various components of the steam sprayer 100 according to the preferred embodiment. Electrical power is generated using the electrical generator 128—preferably driven by drive shaft 130 coupled to the PTO of the tractor 10—and distributed to the various components as indicated by the dashed lines. In particular, electrical power is provided to:

water supply pump 142 for providing water to the water heating tank 116 via water supply conduit 140;

the water heating tank 116 for heating the supplied water to a predetermined hot water temperature, for example, in the temperature range between 80° C. and 100° C.;

the air compressor 132 for providing compressed air to the water heating tank 116 at a pressure in the range of 10 to 150 psi;

each of the steam generators 120 for generating a substantially constant stream of steam at a temperature above 110° C. and at a pressure in the range of 10 to 150 psi; and,

an electrical drive of the nozzle adjusting mechanism 136, for example, for powering a hydraulic pump providing hydraulic pressure to hydraulic actuators for vertically adjusting the steam spraying nozzles 122.

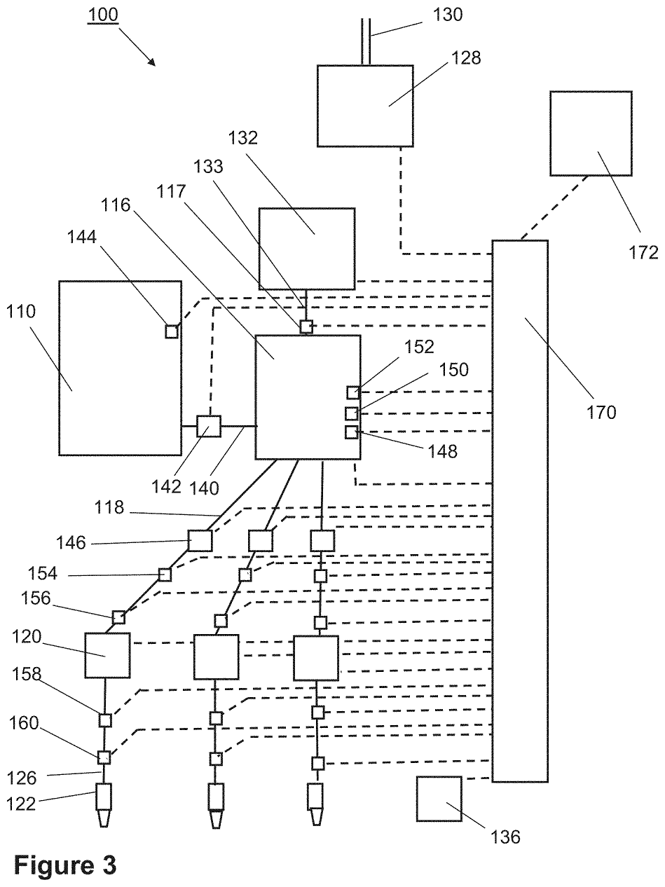

FIG. 3 illustrates the control circuitry for controlling operation of the various components of the steam sprayer 100 according to the preferred embodiment. The control circuitry comprises controller 170, for example, a Field-Programmable Gate Array (FPGA) type microprocessor connected to:

steam pressure sensors 158 and steam temperature sensors 160, for example, disposed in each of the steam conduits 126, for sensing pressure and temperature of the steam sprayed from the respective steam spraying nozzle;

hot water pressure sensors 154 and hot water temperature sensors 156, for example, disposed in each hot water conduit 118 between the PSV 146 and the steam generator 120, for sensing pressure and temperature of the hot water provided to each of the steam generators 120;

water heating tank pressure sensor 148 and a water heating tank temperature sensor 150 disposed in the water heating tank 116 for sensing pressure and temperature in the water heating tank 116;

water heating tank fill level sensor 152 disposed in the water heating tank 116 for sensing a fill level in the water heating tank 116;

water storage tank fill level sensor 152 disposed in the water storage tank 110 for sensing a fill level in the water storage tank 110;

each of the steam generators 120;

each of the PSVs 146;

the water heating tank 116;

the water supply pump 142;

the air compressor 132;

water heating tank pressure control valve 117, preferably comprising a relief valve mechanism for fail-safe overpressure protection of the water heating tank 116;

the electrical generator 128;

the nozzle adjusting mechanism 136; and, Human Machine Interface (HMI) 172, for example, a touch screen, for receiving user input data and displaying operating parameters of the steam sprayer 100.

During operation, the controller 170 controls:

the provision of power to the water heating tank 116;

the provision of power to each of the steam generators 120;

the provision of power to the air compressor 132; and,

the operation of each of the PSVs 146,

in dependence upon:

steam pressure and steam temperature data received from the steam pressure sensors 158 and the steam temperature sensors 160;

hot water pressure and hot water temperature data received from hot water pressure sensors 154 and the hot water temperature sensors 156;

water heating tank pressure and water heating tank temperature data received from the water heating tank pressure sensor 148 and the water heating tank temperature sensor 150; and,

user input data received from the HMI 170,

such that a substantially constant stream of steam at a temperature above 110° C. and at a pressure in the range of 10 to 150 psi is provided to each of the steam spraying nozzles 122 while the steam sprayer 100 is moved in a forward direction at a predetermined speed.

Furthermore, the controller 170 preferably ensures safe operation of the steam sprayer 100 by:

controlling the fill level of the water heating tank 116 and controlling operation of the water supply pump 142 such that the water heating tank 116 is filled to a predetermined operating fill level;

stopping provision of electrical power to the water heating tank 116 and the steam generators 120 when the fill level is below a predetermined minimum fill level threshold and providing a warning signal to the HMI;

stopping provision of electrical power to the water heating tank 116 and the steam generators 120 when the water heating tank pressure is below a predetermined minimum water heating tank pressure and providing a warning signal to the HMI;

providing an indication of a fill level in the water storage tank 110 to the HMI and providing a warning when the fill level is below a predetermined minimum fill level threshold;

stopping provision of electrical power to a steam generator 120 when the hot water pressure received from the respective hot water pressure sensor 154 is below a predetermined minimum hot water pressure and providing a warning signal to the HMI; and,

stopping provision of electrical power to the air compressor 132 when the water heating tank pressure is above a predetermined maximum water heating tank pressure and providing a warning signal to the HMI.

Preferably, the control circuitry is implemented using conventional Controller Area Network (CAN bus) technology, typically enabling integration of the control of the steam sprayer 100 into the control network of a standard tractor 10 with the HMI 172 being placed in the tractor cabin 14. This allows operator control of the steam sprayer 100 while the operator is seated in the tractor cabin 14 and, furthermore, enables integration of the steam sprayer operation with the operation of the tractor 10, for example, automatically adjusting the steam parameters, height H_{N} of the steam nozzles 122, PTO power provision to the electrical generator 128, and the speed of the tractor 10 (for example, a minimum speed of 5 to 6 mph).

Optionally, the water/steam system of the steam sprayer 100 is provided with self-cleaning technology such as, for example, anode protection and/or rinsing with a cleaning agent, to prevent/remove corrosion and/or deposits without the need for substantial disassembly.

It is noted that while the steam sprayer 100 is described hereinabove as a pull-type unit with a drawbar, the steam sprayer 100 may also be implemented for being mounted to a three-point hitch of the tractor 10 or being provided as a self-propelled unit.

Furthermore, the support frame 102 may be adapted for enabling folding of the span in a conventional manner—for example, by providing the support frame 102 as a center portion having a left-hand side and a right-hand side wing attached thereto with the wings being pivotally movable in an upward or rearward direction—for facilitating transport of the steam sprayer 100 to and from a field.

The present invention has been described herein with regard to preferred embodiments. However, it will be obvious to persons skilled in the art that a number of variations and modifications can be made without departing from the scope of the invention as described herein.

1. A steam sprayer for delivering steam onto and beneath a field surface, said steam sprayer comprising:
a support frame;
a plurality of steam spraying nozzles mounted to the support frame and oriented substantially downwardly to spray steam onto and beneath the field surface;
at least a steam generator connected to the steam spraying nozzles to provide steam thereto;
a water heating tank connected to each of the at least a steam generator to provide heated water at a substantially constant pressure thereto;
an air compressor operable to provide compressed air to the water heating tank to pressurize the water heating tank; and
a power source operable to provide power to the water heating tank and each of the at least a steam generator.

2. The steam sprayer according to claim 1, further comprising:
a water storage tank and a water pump connected to the water heating tank to provide water thereto.

3. The steam sprayer according to claim 2, further comprising:
at least a pressure sustaining valve interposed between the at least a steam generator and the water heating tank.

4. The steam sprayer according to claim 3 wherein each steam generator is individually connected to the water heating tank.

5. The steam sprayer according to claim 4 wherein each steam generator is connected to a minimum of one steam spraying nozzle.

6. The steam sprayer according claim 1, further comprising:
an adjusting mechanism mounted to the support frame to adjust a distance between the field surface and the steam spraying nozzles.

7. The steam sprayer according to claim 1, further comprising:
a powered vehicle operable to move the steam sprayer in at least a forward direction.

8. The steam sprayer according claim 7, further comprising:
a shroud extending a predetermined distance from the steam spraying nozzles in a rearward direction,
said shroud forming an enclosure above the field surface for containing the steam therein.

9. The steam sprayer according to claim 2, further comprising:
at least a steam pressure and a steam temperature sensor operable to sense pressure and temperature of the steam sprayed from at least one steam spraying nozzle;
a processor connected to:
the at least a steam pressure and a steam temperature sensor;
the power source;
the air compressor;
the water pump; and
a human machine interface,
the processor being operable to control:
provision of power to the water heating tank and each of the at least a steam generator;
provision of water to the water heating tank; and
provision of compressed air to the water heating tank,
in dependence upon:
steam pressure and steam temperature data received from the least a steam pressure and a steam temperature sensor; and
user input data received from 5 the human machine interface.

10. The steam sprayer according to claim 9, further comprising:
a water heating tank pressure and a water heating tank temperature sensor disposed in the water heating tank and connected to the processor to sense pressure and temperature in the water heating tank and to provide water heating tank pressure and water heating tank temperature data to the processor.

11. The steam sprayer according to claim 10, further comprising:
a water heating tank fill level sensor disposed in the water heating tank and connected to the processor to sense a fill level in the water heating tank and to provide water heating tank fill level data to the processor.

12. The steam sprayer according to claim 11, further comprising:
a hot water pressure sensor and a hot water temperature sensor disposed between the water heating tank and the at least a steam generator and connected to the processor to sense pressure and temperature of the hot water provided to the at least a steam generator and to provide hot water pressure and hot water temperature data to the processor.

13. The steam sprayer according to claim 11 further comprising:
a water storage tank fill level sensor disposed in the water storage tank and connected to the processor to sense a fill level in the water storage tank and to provide water storage tank fill level data to the processor.

14. A steam sprayer operable to deliver steam onto and beneath a field surface, said steam sprayer comprising:
a support frame covering a span of at least 20 feet to a maximum 200 feet;
a plurality of steam spraying nozzles mounted to the support frame along the span thereof and oriented substantially downwardly to spray steam onto and beneath the field surface;
at least one steam generator connected to the steam spraying nozzles to provide steam thereto;
a water supply operable to provide heated water at a substantially constant pressure to each of the steam generators; and
a power source operable to provide power to each of the steam generators.

15. The steam sprayer according to claim 14 wherein each steam generator is connected to at least one steam spraying nozzle.

16. The steam sprayer according to claim 14, further comprising:
an adjusting mechanism mounted to the support frame to adjust a distance between the field surface and the steam spraying nozzles.

17. The steam sprayer according to claim 14 comprising a powered vehicle operable to move the steam sprayer in at least a forward direction.

18. The steam sprayer according to claim 17, further comprising:
a shroud extending a predetermined distance from the steam spraying nozzles in a rearward direction,
said shroud forming an enclosure above the field surface to contain the steam therein.

19. The steam sprayer according to claim 14, further comprising:
at least a steam pressure and a steam temperature sensor to sense pressure and temperature of the steam sprayed from at least one steam spraying nozzle;
a processor connected to:
the at least a steam pressure and a steam temperature sensor;
the power source;
water supply; and
a human machine interface,
the processor for controlling being operable to control:
provision of power to the at least a steam generator; and
provision of the heated water to the at least a steam generator;
in dependence upon:
steam pressure and steam temperature data received from the least a steam pressure and a steam temperature sensor; and
user input data received from the human machine interface.

20. A method of delivering steam onto and beneath a field surface, said method comprising the steps of:
a. providing a support frame covering a span of at least 20 feet to a maximum 200 feet and having a plurality of steam spraying nozzles mounted thereto along the span and oriented substantially downwardly to spray steam onto and beneath the field surface; and
b. providing a substantially constant stream of steam at a temperature above 110° C. and at a pressure in the range of 10 to 150 psi to each of the steam spraying nozzles.

21. The method according to claim 20, said method further comprising the steps of:
c. providing at least one steam generator connected to the steam spraying nozzles to provide steam thereto;
d. providing is a water supply operable to provide heated water at a substantially constant pressure to each of the steam generators;
e. providing a power source operable to provide power to each of the steam generators;
f. providing at least a steam pressure and a steam temperature sensor operable to sense pressure and temperature of the steam sprayed from at least one steam spraying nozzle;
g. providing a processor connected to:
the at least a steam pressure and a steam temperature sensor;
the power source;
water supply; and
a human machine interface,
h. using the processor controlling:
provision of power to the at least a steam generator; and
provision of the heated water to the at least a steam generator;
i. in dependence upon:
steam pressure and steam temperature data received from the least a steam pressure and a steam temperature sensor; and
user input data received from the human machine interface, and
j. moving the steam sprayer in a forward direction at a predetermined speed.
